(19) United States
(12) Patent Application Publication
(10) Pub. No.: US 2023/0325472 A1
(43) Pub. Date: Oct. 12, 2023

(54) identification of art /artifacts.

(71) Applicant: Menni Menashe Zinger, Ashkelon (IL)

(72) Inventor: Menni Menashe Zinger, Ashkelon (IL)

(21) Appl. No.: 17/702,832

(22) Filed: Mar. 24, 2022

(51) Int. Cl. G06F 21/10; G06Q 20/38

(52) U.S. Cl. CPC G06F 21/10; G06Q 20/389; G06Q 2220/145; G06Q 2220/16; G06Q 2220/18

(57) ABSTRACT

I present here methods to have 100 percent identification of an art /artifact at digital format.

### DESCRIPTION

The n.f.t /nft market becoming very popular at the last year and high level of Certance identification are very needed in order to keep this market /business alive, other wise there would be no value to invest at that market and stealing and fraud’s would ruin this business .

I wrote here about using a licensed software, exclusive one to this field or some software with coordination between them with updates every second or other short time and using a sign of whole lock or other agreed sign that will appear only at the authentic owner /buyer and using a serial number /i.d. number and name /nickname of buyer at the final stage that could be printed and /or send as attached file at agreed format as word /pdf /jpg other and also magnetic signature way of keeping data in order to prevent frauds beyond time and preventing stealing of expensive / successful artifacts /art peace beyond time.

### CLAIMS AND METHODS

using an whole/complete lock sign only to the customer who will by an art collection picture / rare thing/artifact and using a licensed software, exclusive one to this field or number of software/s with coordination between them with updates every second or other short time between them and using a sign of whole lock or other agreed sign that will appear only at the authentic owner /buyer and who will do it first at the world and using licensing and coordination between several software’s with updates every second or even less time and for any other person that will use the software that will be used for that market /business and would be without approval from those software’s with licensing and uniqueness with exclusivity would show broken lock sign and the wining customer can represent the screen to whom he want and interested, near him and /or by showing a clip /video /photo/screen/print screen, photo of complete lock and the art peace photo and serial number and /or name /i.d/nick name of buyer at the final stage that could be printed/print screen option and /or send as attached file at agreed format as word /pdf /jpg other and also magnetic signature way of keeping data in order to prevent frauds beyond time and preventing stealing of expensive / successful artifacts /art peace beyond time and by using those methods the customer would have a file digital file, with serial number, sign of complete lock /other agreed sign at the exclusive software at the world /country and name /i.d. also it is possible to use magnetic signature kept of data /approval that the buyer is the first to by the artifact at the regular time flow without interfering and manipulations beyond time in order to prevent frauds and stealing of artifact that become very expensive and popular.

1. Using quantum mechanics for that purpose also inspiration zones with increased power for example 1000:1,1,000,000:1 1b:1, 1quardilion:1etc.

2. Using electric field frequency, exactly as needed to insert or take out particles like ions, electrons neutrons, protons etc.,charge,and or energy, electric charge from ions.

3. Using radio waves and/or t.v. waves to insert or taking out particles, charge, etc. from the formulas.

4. Using electric current at the right strength, frequency to pull or track out particles and/or charge, power, etc.

5. Using compressor to compress co and/ or o into H2O, by high pressure cans containing those gas
adjusted, inserted into H2O.
inserting hydrogen into the formula, h2o.

6. It was claim 10 first now it is claim 6.using my original basic formula The formula h2o5 for example might have energy influence on the environment and using this power, energy included/contained in it can produce energy that can be use for example for power station.

7. Using magnetic and /or electromagnetic power to insert material like hydrogen, oxygen carbon co to the water or take them out including using exact frequency of exact material for accuracy.

8. Using iron in order to get out oxygen from h2o, h2o5 etc. also I noticed that iron has magnetic caricature and steel do not has such a caricature and I noticed that the gray and silver color metals do not has magnetic caricature in front of gold, bronze, copper, and difference is the reaction to oxygen, iron react the best to oxygen and collect it, so oxygen cause magnetic influence also it can be changed I assume by using electric and /or magnetic influence and /or movement also copper and /or magnesium can be used in order to dissolve oxygen from water h2o or h2o5 and left with hydrogen that can be used as fuel that burn at relatively low temperature or using ion after ion as I wrote at my invention that will be attracted by using ion tractor and /or magnetic power that will be aimed towards the molecules of water h20 or h2o5 or other materials and /or using electromagnetic power in order to tract ions/ electrons /protons and /or electric filed and /or t.v. waves and /or radio waves. using calcium in order to take hydrogen from water, h2o, h2o5, than using the hydrogen and /or oxygen as fuel for cars, vehicles of all kinds, ships, plains, trains, busses, motorcycle etc. power stations.

9. Using cans with pipe inserting the pipe into the water and pushing a button, handle to compress gas like preon/ freon spelling correction or co or o etc.

10. Changed order of claims, It was claim 6 first now it is claim 10. Using tartarzine instead of terterazine and /or detergents as a supplement to the base formula in order to produce energy also with other supplement also for all kinds of vehicles such as cars, trucks, ships, plains, motorcycles, space ships, space stations and for buildings, houses, power stations of all kinds and scales.

11. Usingfennel plant to absorb poisoned gas also for vehicles, like cars, trucks, bikes,ships plains etc. also for factories, paints, power stations etc.

12. Using cohel and /or alcohol for motoring vehicles by separating CHO, first preon /Freon in order to take out oxygen than warming or touching it with water that take the hydrogen into it, if we touch with water it need to use Freon in order to take out oxygen from a separated can and left with hydrogen that will be used as a fuel also by the ions that will be attracted by using ion tractor, magnetic power with accurate frequency and /or electro magnetic power, waves, t.v. waves and or radio waves and / or electric filed .

13. Using enzymes to dis apart C,H,O at vehicles as cars, trucks, ships, plains satellite, space ships, space stations etc. there enzymes at the body of humans that helps the body to dis apart cohel and alcohol and it can be used at vehicles and power stations and iron and/or copper and /or magnesium can be used for dis apart oxygen and calcium for dis apart hydrogen.

14. Using ROH as fuel for vehicles and /or power stations, plains, space ships, ships, satellites etc. by using Freon in order to take out oxygen and calcium in order to take out hydrogen.

15. Using c10h8 as fuel for vehicles of any kind as cars, trucks, busses, trains, ships. space ships, space stations, plains motorcycle etc. and /or power stations of different scales.
